(19) United States
(12) Patent Application Publication
(10) Pub. No.: US 2004/0181527 A1
(43) Pub. Date: Sep. 16, 2004

(54) Robust system for interactively learning a string similarity measurement

(75) Inventors: Douglas R. Burdick, Ithaca, NY (US); Robert J. Szczerba, Endicott, NY (US)

Correspondence Address: TAROLLI, SUNDHEIM, COVELL & TUMMINO LLP, 1111 LEADER BLDG., 526 SUPERIOR AVENUE, CLEVELAND, OH, 44114, US

(73) Assignee: Lockheed Martin Corporation

(21) Appl. No.: 10/385,897

(22) Filed: Mar. 11, 2003

(51) Int. Cl. G06F 17/30; G06F 7/00

(52) U.S. Cl. 707/6

(57) ABSTRACT

A system learns a string similarity measurement. The system includes a set of record clusters. Each record in each cluster has a list of fields and data contained in each field. The system further includes a set of initial weights for determining edit distance measurements and an initial field similarity function for assigning a field similarity score to each pair of field values in each cluster. The set of initial weights and the field similarity function are modified by user feedback to produce an optimal set of edit-distance weights and an optimal field similarity function.

### FIELD OF THE INVENTION

The present invention relates to a system for interactively learning, and more particularly, to a system for interactively learning a string similarity measurement.

### BACKGROUND OF THE INVENTION

In today's information age, data is the lifeblood of any company, large or small, federal or commercial. Data is gathered from a variety of different sources in a number of different formats or conventions. Examples of data sources would be: customer mailing lists, call-center records, sales databases, etc. Each record contains different pieces of information (in different formats) about the same entities (customers in this case). Data from these sources is either stored separately or integrated together to form a single repository (i.e., data warehouse or data mart). Storing this data and/or integrating it into a single source, such as a data warehouse, increases opportunities to use the burgeoning number of data-dependent tools and applications in such areas as data mining, decision support systems, enterprise resource planning (ERP), customer relationship management (CRM), etc.

The old adage “garbage in, garbage out” is directly applicable to this situation. The quality of analysis performed by these tools suffers dramatically if the data analyzed contains redundancies, incorrect, or inconsistent values. This “dirty” data may be the result of a number of different factors including, but certainly not limited to, the following: spelling (phonetic and typographical) errors, missing data, formatting problems (wrong field), inconsistent field values (both sensible and non-sensible), out of range values, synonyms or abbreviations, etc. Because of these errors, multiple database records may inadvertently be created in a single data source relating to the same object (i.e., duplicate records) or records may be created which don't seem to relate to any object (i.e., “garbage” records). These problems are aggravated when attempting to merge data from multiple database systems together, as data warehouse and/or data mart applications. Properly reconciling records with different formats becomes an additional issue here.

A data cleansing application may use clustering and matching algorithms to identify duplicate and “garbage” records in a record collection. Each record may be divided into fields, where each field stores information about an attribute of the entity being described by the record. Clustering refers the step where groups of records likely to represent the same entity are created. This group of records is called a cluster. If constructed correctly, each cluster contains all records in a database actually corresponding to a single unique entity. A cluster may also contain some other records that correspond to other entities, but are similar enough to be considered. Preferably, the number of records in the cluster is very close to the number of records that actually correspond to the single entity for which the cluster was built. FIG. 1 illustrates an example of four records in a cluster with similar characteristics.

Matching is the process of identifying the records in a cluster that actually refer to the same entity. Matching involves searching the clusters with an application specific set of rules and uses a search algorithm to match elements in a cluster to a unique entity. In FIG. 2, the three indicated records from FIG. 1 likely correspond to the same entity, while the fourth record from FIG. 1 has too many differences and likely represents another entity.

Conventional systems of string similarity are variants of an edit-distance function. Edit-distance is the minimum number of character insertions, deletions, and/or substitutions necessary for transforming one string into another string. An example formula may be: Edit-distance=(# insertions)+(# deletions)+(# substitutions).

For example, the edit-distance between “Robert” and “Robbert” would be 1 (the extra ‘b’ inserted). The edit-distance between “Robert” and “Bobbbert” would be 3 (the ‘R’ substituted with the ‘B’ and two extra ‘b’ inserted—1 substitution and 2 insertions).

In the example formula, each difference has the same effect on the similarity measurement (e.g., 1 insertion is equivalent to 1 deletion, so the calculated distance is the same, etc.). Different weights may be assigned to each of these terms, so that certain types of differences factor more or less heavily into the edit-distance calculation. Weighted-Edit-Distance=(weight_insert)(#insertions)+(weight_deletions)(#deletions)+(weight_substitutions) (#substitutions). More complex systems for calculating edit-distance may divide a string into sub-strings, compute the edit-distance over the sub-strings, and then combine the sub-string edit-distances.

A conventional record similarity function that may be used during a matching step may be of the form: Record_Similarity (rec_, rec_{—}2)=

$${\sum }_{k = 1}^{k = \vert fields \vert} ( w\_k ) ( Field\_sim ( rec\_ 1. field\_k , rec\_ 2. field\_k ) ) .$$

rec_{—}1 and rec_{—}2 are database records, |fields| is the number of fields in each record, rec_{—}1.field_k is the k-th field of record 1, w_k is a numerical weight, and field_sim is the function that assigns a similarity score to the strings of the field values.

A conventional field_sim function may include variants of the edit-distance, which measures the number of character differences between two strings. If the output from Record_Similarity (rec_{—}1, rec_{—}2) is greater than a predetermined threshold value, then rec_{—}1 and rec_{—}2 are duplicate records. Otherwise, the records are not duplicates and likely refer to different entities. This similarity function may be calculated for every possible pair of records in each cluster.

In the example formula for determining the Record_Similarity of a pair of records, each term has two parts that must be calculated: the field similarity score for each pair of corresponding field values; and the weight (w_k) to assign to each of the field similarity scores when combining the scores together for the entire record.

An example of an issue that may arise when performing this step may include that certain portions of the field value provide less valuable information than others. If a sub-string of a field value is frequently recurring or prone to error, it provides little useful information about what value the string is meant to represent. Thus, it should have a lower impact on the final similarity score than the other sub-strings in the field value. For example, consider the street addresses “104 Brook Street” and “106 Brooke Street”. “Street” is a very commonly occurring sub-string in street addresses, and its effect on the final similarity score should therefore be reduced. Also, house numbers in the street addresses are very prone to errors, so their impact on the calculated similarity score should be reduced as well.

There may also be correlations and dependencies between several record fields that can be used to further refine the similarity score. For example, for addresses, the value for city and state may produce a limited number of values for ZIP code (i.e., Ithaca, N.Y. has the ZIP code 14850). If a record has an unexpected value for a field that violates the dependence (i.e., a record with the address Ithaca, N.Y. 13850), then the system may recognize this as an anomaly that requires additional information to resolve. This is a highly simplified example of anomalies that may be detected.

Most record field data is represented as strings. Hence, while there are conventional systems for determining string similarity measurements (e.g., the numerous variants of the edit-distance, etc.), there are no conventional systems for interactively learning a string similarity measurement. Also, conventional string similarity measurements only take into account the actual values being compared, and do not consider using other available information to refine the similarity measurement (i.e., correlations between record fields, known variances in the accuracy of certain sub-strings within field values, etc.).

One conventional system learns the optimal weights for the edit-distance function. This system receives input as an initial set of training data, and from input learns the optimal parameters to an edit-distance function. This conventional system, however, does not generate training examples to interactively guide the learning process. Thus, the quality of the similarity measurement learned by this conventional system relies heavily on the quality of the training set (i.e., its completeness, accuracy, etc.).

### SUMMARY OF THE INVENTION

A system in accordance with the present invention learns a string similarity measurement. The system may include a set of record clusters. Each record in each cluster has a list of fields and data contained in each field. The system may further include a set of initial weights for determining edit-distance measurements and an initial field similarity function for assigning a field similarity score to each pair of field values in each cluster. The set of initial weights and the field similarity function may be modified by user feedback to produce an optimal set of edit-distance weights and an optimal field similarity function.

A method in accordance with the present invention learns a string similarity measurement. The method may include the steps of: providing a set of record clusters, each record in each cluster having a list of fields and data contained in each field; providing a set of initial weights for determining edit-distance measurements; providing an initial field similarity function for assigning a field similarity score to each pair of field values in each cluster; and modifying the set of initial weights and the field similarity function by user feedback to produce an optimal set of edit-distance weights and an optimal field similarity function.

A computer program product in accordance with the present invention interactively learns a string similarity measurement. The product may include an input set of record clusters. Each record in each cluster has a list of fields and data contained in each field. The product may further include a set of initial weights for determining edit-distance measurements and an initial field similarity function for assigning a field similarity score to each pair of field values in each cluster. The set of initial weights and the field similarity function may be modified by user feedback to produce an optimal set of edit-distance weights and an optimal field similarity function.

### BRIEF DESCRIPTION OF THE DRAWINGS

The foregoing and other advantages and features of the present invention will become readily apparent from the following description as taken in conjunction with the accompanying drawings, wherein:

FIG. 1 is a schematic representation of an example process for use with the present invention;

FIG. 2 is a schematic representation of another example process for use with the present invention; and

FIG. 3 is a schematic representation of an example system in accordance with the present invention.

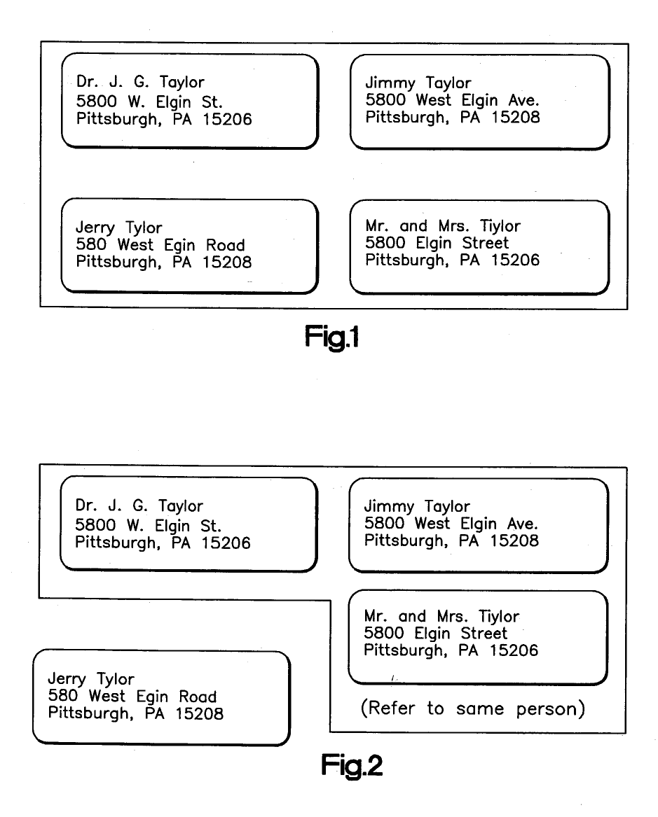

### DETAILED DESCRIPTION OF AN EXAMPLE EMBODIMENT

A system in accordance with the present invention introduces a method to “learn” (as opposed to “compute”) a string similarity measurement for each field of each record of a data collection. After identifying cases that cannot be processed with a high degree of confidence, the system generates training examples that are presented to a user (i.e., a human user, etc.). Based on the feedback from these system-generated training examples, the system may refine the field similarity measurements to process the anomalous cases for a particular data cleansing application.

A field similarity function learned by the system may be edit-distance based, with adjustments for the context of the values. The system may provide a separate similarity function for each field. Each field similarity function may be represented as follows: Field-Similarity-Score (va11, va12)=(W_{ed}) Edit-Distance-Variant (va11, va12)+(W_{ca})Contextual-Adjustment (va1₁, va¹²)+(W_{fa})Frequency-Adjustment (va11, va12). va11 and va12 are the field values being compared. Edit-Distance-Variant, Contextual-Adjustment, and Frequency-Adjustment are functions that return a numerical score based on va11 and va12 values. The weights assigned to each term (W_{ed}, W_{ca}, W_{fa}, respectively) determine the overall effect of the term in computing a final field similarity score.

Initially, the Contextual-Adjustment and Frequency-Adjustment functions may return zero for all inputs. An initial set of weights for the edit-distance function (or information to derive them) may be provided as input. The final output from the system may be, for each field similarity function: an appropriate contextual-adjustment function (likely will return a non-zero value for most inputs); an appropriate frequency-adjustment function (likely will return a non-zero value for a portion of inputs; zero for most); an optimal set of edit-distance weights; and an optimal set of weights for each of the adjustments in the field similarity formula. Individual field similarity scores may be combined to generate a record similarity score. Any edit-distance variant may be used.

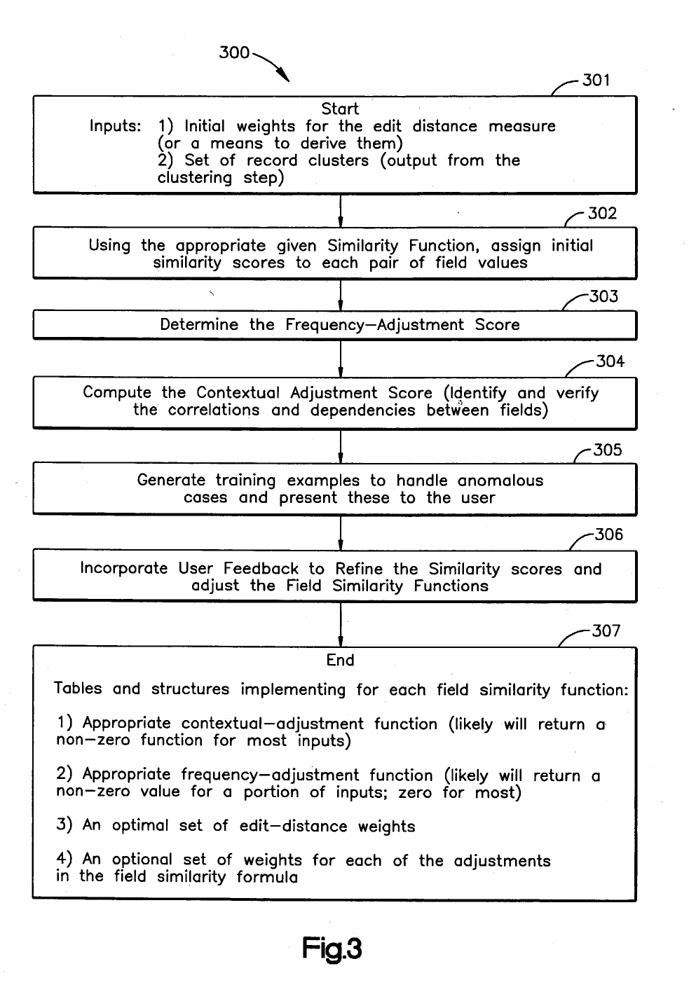

As viewed in FIG. 3, at the highest level, an example system 300 in accordance with the present invention may consist of the following steps. In step 301, the system 300 inputs initial weights for edit distance measurements or a means to derive these measurements and a set of record clusters that may be output from a clustering step of a data cleansing application. Following step 301, the system 300 proceeds to step 302. In step 302, the system 300 assigns an initial similarity score to each pair of field values, using an appropriate similarity function. Each field similarity function may be an edit-distance variant. The weights may be given or derived by the system 300. An example derivation may be: if a dictionary (or look-up table) of correct values for one or more fields is available, the system 300 may perform a correction/validation process on those fields. From this, the system 300 may record the frequency of different types of mistakes (insertions, deletions, substitutions, etc.) and adjust the weights in the edit-distance function, accordingly.

If training data is available, appropriate edit-distance weights may be learned using a conventional automated learning method. For example, the training data may be a pair of values for the record field that are determined to be identical.

Following step 302, the system 300 proceeds to step 303. In step 303, the system 300 determines a Frequency-Adjustment Score. A conventional raw edit-distance measure alone produces certain portions of the field value having less valuable information. If a sub-string of a field value is frequently recurring or prone to error, this sub-string may provide little useful information about what value the string represents.

The system 300 may adjust the similarity score to account for this factor utilizing a Frequency-Adjustment portion of the Field Similarity score. During step 303, the system 300 determines optimal parameters for calculating a portion of the similarity score for each record field.

The system 300 may determine frequently occurring sub-strings that may be discounted in a field similarity measurement (i.e., “stop words”, etc.). The system 300 may examine the contents of the fields as sub-strings, and store the frequency of their occurrence. For example, the system 300 may determine that short, high frequency sub-strings (i.e., under 4 characters, etc.) are likely to be omitted or replaced with the wrong value. The system 300 may drop these entirely from the field similarity measurement or give a “reduced” penalty for not containing them. Candidate stop words may be presented to a user, and the user may determine how they should be processed.

The system 300 may also suggest equivalent classes for frequently occurring sub-strings that occur in field values. For example, for customer address records, after examining the database, the system 300 may determine that the strings “Street”, “Road”, “Avenue”, “Way”, “Lane”, and “Drive” appear in a significant percentage of the street address fields. Further, these strings may generally be the last sub-string of a street address value with only one of them appearing in each street address (with few exceptions). These strings may be an equivalent class of values and all serve the same purpose in a street address.

Thus, the system 300 may present these values to a user for verification of this hypothesis. The system 300 may present these values and a query in a GUI interface. The user may then select the values from the list that are equivalent. Additionally, the system 300 may query a user about how likely these are to be correct and not exchanged with another equivalent value (i.e., “Brook Street” becomes “Brook Road”, since Street and Road were interchanged, etc.). The system 300 may translate a relatively granular scale presented to the user into a numerical value that goes into a Frequency-Adjustment function.

One example Frequency-Adjustment function may store the Frequency-Adjustment score for each sub-string in a hash-table. The system 300 determines whether the values being compared contain a sub-string in the table. If they do, the system 300 retrieves the appropriate Frequency-Adjustment scores in the table.

Following step 303, the system 300 proceeds to step 304. In step 304, the system 300 may compute a Contextual Adjustment score (i.e., identifying and verifying correlations and dependencies between fields, etc.). The system 300 then examines the database to determine the existence of dependencies between field values.

A dependency may indicate that the values for a field (or combination of fields) may be used to predict a value in another field. For example, in addresses, the combination of city and state values may be used to predict the value for ZIP code. Allowing for errors and alternative representations, these dependencies may not always be accurate. Conventional systems settle for utilizing statistically significant correlations. For example, perfect functional dependencies may be as follows: for every possible value X in field A, the following rule may apply: IF (Field A of Record 1 has value X) THEN (Field B of Record 1 has value Y).

The system 300 may determine rules, such as FOR a d % of the possible values for field A, then either of the following is true: 1) IF (field A of Record 1 has value X) THEN (field B of Record 1 has value Y 100% of the time) OR 2) IF (field A of Record 1 has value X) AND (at least s % of all Records have value X for field A) THEN (field B of Record 1 has value Y c % of the time), where d, s, c are numbers less than 100%. These rules may be variants of association rules with s being “support” of the rule and c being “confidence” of the rule, respectively. The variant is that a rule is only created if the association rule holds for a significant portion of the values for field A. Rule 1 is a perfect dependency. Rule 2 processes possible errors by relaxing the constraint for frequent values of field A. While these example rules are simple, the same concepts may be extended to allow dependencies in multiple fields and clauses with multiple levels of s and c for different field combinations.

Rules that are applied to a large statistical portion of the fields may be presented to a human user for feedback as to whether the system 300 has made valid inferences. There are numerous ways to measure statistical significance. The level of significance in which the user is interested will likely determine the values assigned to d, s, and c in the rules.

If a user is a domain expert, she/he may also suggest rules or types of rules for which to look. User suggestions may speed up the system 300, but are not necessary. For example, a user could suggest between which fields to look for dependencies. The system 300 may also use conventional methods for efficiently computing these association rules for large data sets.

An example Contextual-Adjustment function may store the Contextual-Adjustment score for each rule in a table. The system 300 may then determine whether the records containing the values being compared match any of the rules. If they do, the system 300 retrieves an appropriate Contextual-Adjustment score from the table and assigns that score to the field similarity score.

Following step 304, the system 300 proceeds to step 305. In step 305, the system 300 may generate training examples to process the anomalous cases and present them to a user. These training examples allow the system 300 to process cases where the dependency rules have been violated, (i.e., the value present significantly diverges from the expected value, etc.). Ideally, the number of these cases will be insignificant or small. The anomalous cases may be presented to a user, along with an explanation of why the system 300 has inferred that the values may be incorrect. For example, the system 300 may infer a value is anomalous if the edit-distance portion of a similarity measurement is drastically outside a predetermined range.

Following step 305, the system 300 proceeds to step 306. In step 306, the system 300 may incorporate user feedback to refine the similarity scores and adjust the field similarity functions. The system 300 executes the similarity scoring process again for the ambiguous cases with the new, improved similarity measurement functions. The ambiguous cases may be assigned an improved score based on the new function parameters. Step 306 may be iterated several times as needed to further refine any component(s) of the field similarity measurements (i.e., Edit-Distance Variant, Frequency Adjustment, Contextual Adjustment, etc.).

Following step 306, the system 300 proceeds to step 307. In step 307, the example system 300 outputs an appropriate contextual-adjustment function (likely will return a non-zero value for most inputs); an appropriate frequency-adjustment function (likely will return a non-zero value for a portion of inputs; zero for most); an optimal set of edit-distance weights; and an optimal set of weights for each of the adjustments in the field similarity function. Individual field similarity scores may be combined to generate a record similarity score. Any edit-distance variant may be used.

An example computer program product in accordance with the present invention may interactively learn a string similarity measurement. The product may include an input set of record clusters, a set of initial weights for determining edit-distance measurements, and an initial field similarity function for assigning a field similarity score to each pair of field values in each cluster. Each record in each cluster may have a list of fields and data contained in each field. The set of initial weights and the field similarity function may be modified by user feedback to produce an optimal set of edit-distance weights and an optimal field similarity function.

Another example system in accordance with the present invention addresses the first step of assigning a field similarity score to a pair of field values. This example system may interactively learn an intelligent character string similarity function for record fields in a database. Since most record data is represented as alphanumeric strings, the problem of measuring string similarity and record field similarity are identical. This string similarity function may be used during the matching step of a data cleansing application to identify sets of database records actually referring to the same real-world entity.

Given a pair of character string values for a field, the function may assign a similarity score quantifying the similarity of the respective strings. This example system may include a mechanism for generating training data that may be used to refine the field similarity function through an interactive learning session with a user. The similarity function may be refined to optimally process anomalous cases. Preferably, each record field has its own field similarity function defined.

This learning feature may increase the quality of field similarity measurements used during a matching step, which thereby may improve the overall accuracy of a data cleansing process in detecting and correcting duplicate records. The system is made interactive by including the capacity for generating an “intelligent” set of training examples. The system thereby reduces the reliance on an expert creating such a training set.

Additionally, this example system may use additional information to intelligently “adjust” the similarity score for one or more record fields. This ability produces a field similarity measurement more robust to mistakes and alternative representations for values that may be present in the data.

From the above description of the invention, those skilled in the art will perceive improvements, changes and modifications. Such improvements, changes and modifications within the skill of the art are intended to be covered by the appended claims.

Having described the invention, the following is claimed:

1. A system for learning a string similarity measurement, said system comprising:
a set of record clusters, each record in each cluster having a list of fields and data contained in each said field;
a set of initial weights for determining edit-distance measurements;
an initial field similarity function for assigning a field similarity score to each pair of field values in each cluster;
said set of initial weights and said field similarity function being modified by user feedback to produce an optimal set of edit-distance weights and an optimal field similarity function.

2. The system as set forth in claim 1 further including a select group of record pairs that are used to interactively determine said optimal set of edit-distance weights.

3. The system as set forth in claim 2 wherein said select group of record pairs are outputted to a user to for interactively determining said optimal set of edit-distance weights.

4. The system as set forth in claim 3 wherein said initial field similarity function is modified by the user subsequent to the user reviewing said select group of record pairs.

5. The system as set forth in claim 4 wherein said system outputs a record similarity function improved by the input of the user.

6. The system as set forth in claim 5 wherein said system comprises part of a matching step in a data cleansing application.

7. A method for learning a string similarity measurement, said method comprising the steps of:
providing a set of record clusters, each record in each cluster having a list of fields and data contained in each field;
providing a set of initial weights for determining edit-distance measurements;
providing an initial field similarity function for assigning a field similarity score to each pair of field values in each cluster;
modifying the set of initial weights and the field similarity function by user feedback to produce an optimal set of edit-distance weights and an optimal field similarity function.

8. The method as set forth in claim 7 further including the step of selecting a group of record pairs that are used to interactively determine the optimal field similarity function.

9. The method as set forth in claim 7 further including the step of outputting the selected group of record pairs to a user for interactively determining the optimal field similarity function.

10. The method as set forth in claim 7 further including the step of modifying the initial field similarity function by the user subsequent to the user reviewing the selected group of record pairs.

11. The method as set forth in claim 7 further including the step of outputting a record similarity function improved by the input from the user.

12. The method as set forth in claim 7 wherein said method is conducted as part of a matching step in a data cleansing application.

13. A computer program product for interactively learning a string similarity measurement, said product comprising:
an input set of record clusters, each record in each cluster having a list of fields and data contained in each field;
a set of initial weights for determining edit-distance measurements;
an initial field similarity function for assigning a field similarity score to each pair of field values in each cluster;
said set of initial weights and said field similarity function being modified by user feedback to produce an optimal set of edit-distance weights and an optimal field similarity function.

14. The computer program product as set forth in claim 13 further including a selected group of record pairs that are used to determine said optimal set of edit-distance weights and said optimal field similarity function.

15. The computer program product as set forth in claim 14 wherein the selected group of record pairs are outputted to a user for determining said optimal set of edit-distance weights and said optimal field similarity function.

16. The computer program product as set forth in claim 15 wherein a record similarity score is modified by the user subsequent to the user reviewing the selected group of record pairs.

17. The computer program product as set forth in claim 16 wherein said computer program product outputs a record similarity function improved by the input from the user.

18. The computer program product as set forth in claim 17 wherein said computer program product comprises part of a matching step in a data cleansing application.
